(19) United States
(12) Patent Application Publication
(10) Pub. No.: US 2016/0105310 A1
(43) Pub. Date: Apr. 14, 2016

(54) DEPLOYING DISK IMAGES

(71) Applicant: Microsoft Corporation, Redmond, WA (US)

(72) Inventors: Peter John Hill, Seattle, WA (US); Gary N. Wright, Santa Clara, CA (US); Darren P. Loher, Kirkland, WA (US)

(21) Appl. No.: 14/512,040

(22) Filed: Oct. 10, 2014

(51) Int. Cl. H04L 12/24; H04L 29/08

(52) U.S. Cl. CPC H04L 41/0806; H04L 41/5051; H04L 67/10

(57) ABSTRACT

The present invention extends to methods, systems, and computer program products for deploying disk images. Various common disk images can be examined (e.g., within a data center) to identify a set of blocks that match between multiple, related images (i.e., common blocks). Both the common blocks and different blocks can be stored in a composite disk image. When a request for a machine running a specific production disk image is made, hardware with a pre-cached composite disk image can be located. Rules can be applied to the composite disk image to transform the composite disk image into the requested production disk image.

### CROSS-REFERENCE TO RELATED APPLICATIONS

Not Applicable

### BACKGROUND

### Background and Relevant Art

In a datacenter environment, new servers can be brought into service at a high rate. Latency between a request for new capacity and availability of the new capacity is driven at least in part by the amount of time required to move disk images to the desired servers. Increased latency in turn increases the delay between receiving a request for capacity and the requested capacity becoming available for use.

### BRIEF SUMMARY

The present invention extends to methods, systems, and computer program products for deploying disk images. A request to deploy a production disk image, including one or more software components, is received. A composite disk image is accessed. The composite disk image includes a plurality of data blocks and one or more transformation rules. The plurality of data blocks contains data for a plurality of different software components. The plurality of data blocks includes one or more common data blocks and one or more unique data blocks. The one or more common data blocks are common to a plurality of different possible production disk images. The one or more unique data blocks are unique between at least some of the plurality of different possible disk images. The one or more transformation rules define how to process the plurality of data blocks to deploy any of a plurality of different production disk images.

A transformation rule corresponding to the production disk image is identified based on the received request. The transformation rule is identified from among the one or more transformation rules included in the composite disk image. The production disk image is deployed to a portion of a storage device by applying the transformation rule to the plurality of data blocks.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only some implementations of the invention and are not therefore to be considered to be limiting of its scope, the invention will be described and explained with additional specificity and detail through the use of the accompanying drawings in which:

FIGS. 1A-1C illustrate an example computer architecture that facilitates deploying disk images.

FIG. 2 illustrates a flow chart of an example method for deploying disk images.

FIG. 3 illustrates an example computer architecture that facilitates deploying disk images.

FIG. 4 illustrates an example computer architecture that facilitates deploying disk images.

### DETAILED DESCRIPTION

The present invention extends to methods, systems, and computer program products for deploying disk images. A request to deploy a production disk image, including one or more software components, is received. A composite disk image is accessed. The composite disk image includes a plurality of data blocks and one or more transformation rules. The plurality of data blocks contains data for a plurality of different software components. The plurality of data blocks includes one or more common data blocks and one or more unique data blocks. The one or more common data blocks are common to a plurality of different possible production disk images. The one or more unique data blocks are unique between at least some of the plurality of different possible disk images. The one or more transformation rules define how to process the plurality of data blocks to deploy any of a plurality of different production disk images.

A transformation rule corresponding to the production disk image is identified based on the received request. The transformation rule is identified from among the one or more transformation rules included in the composite disk image. The production disk image is deployed to a portion of a storage device by applying the transformation rule to the plurality of data blocks.

Implementations of the present invention may comprise or utilize a special purpose or general-purpose computer including computer hardware, such as, for example, one or more processors and system memory, as discussed in greater detail below. Implementations within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, PDAs, tablets, pagers, watches, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

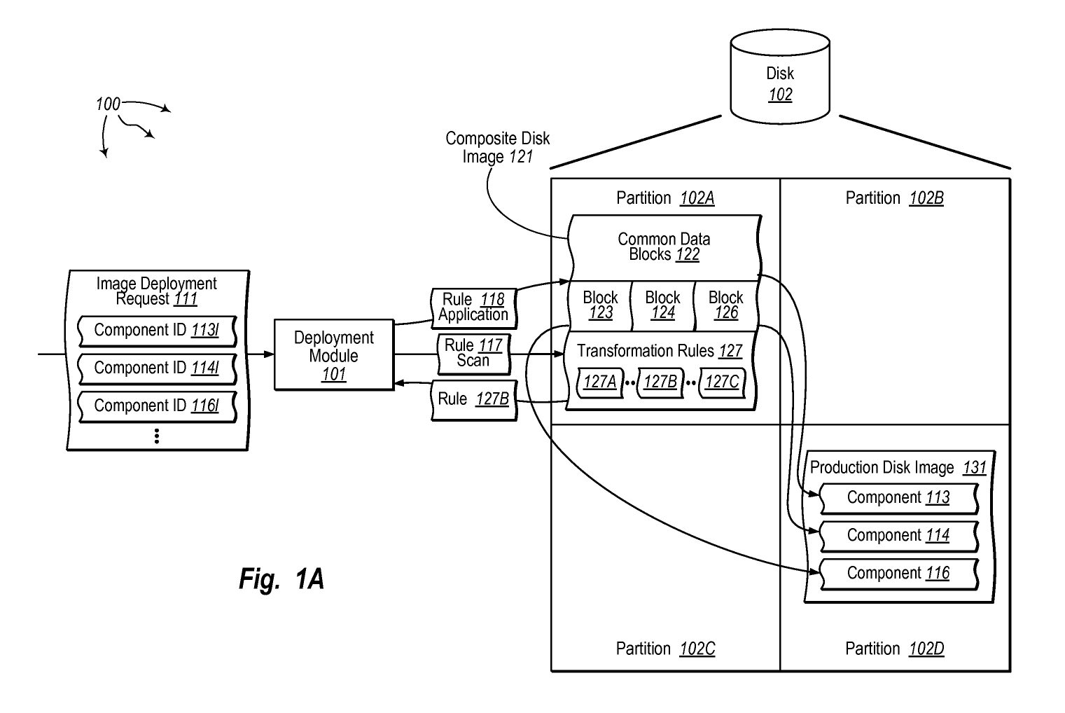

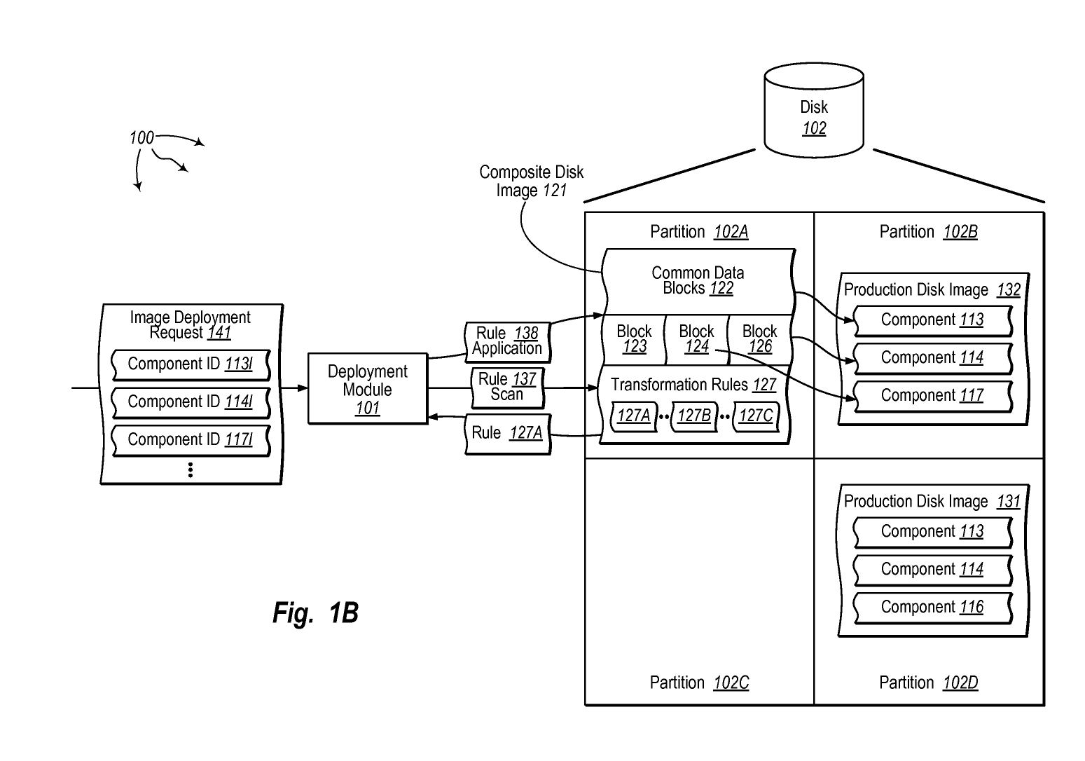

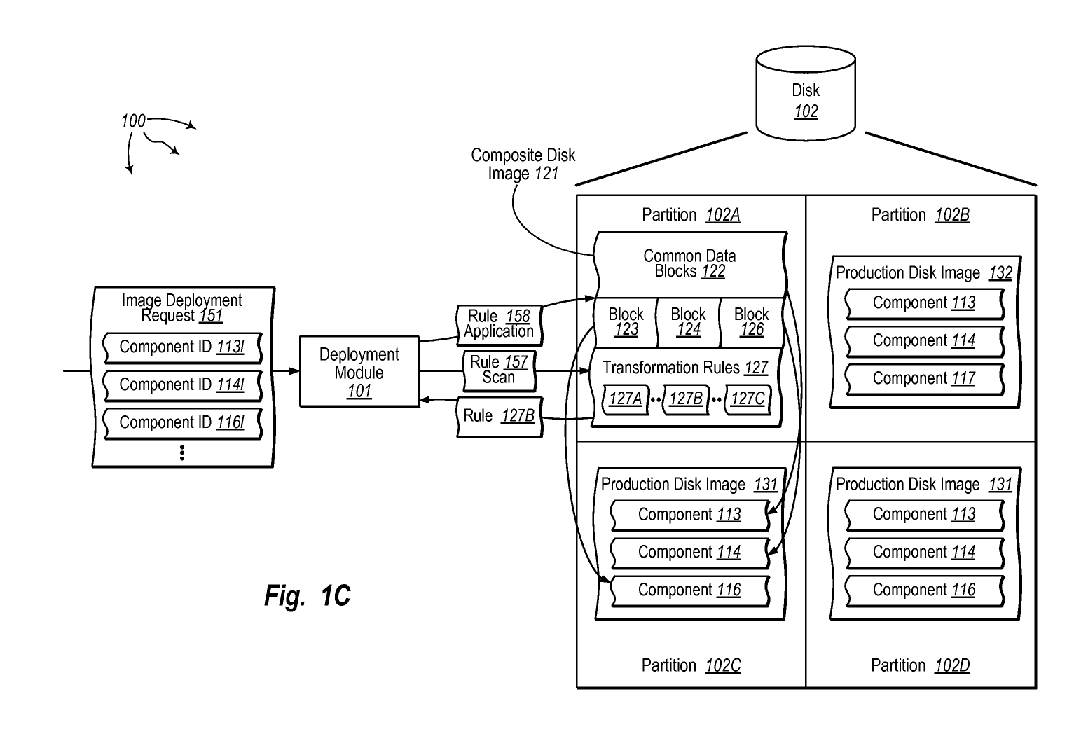

FIGS. 1A-1C illustrates an example computer architecture 100 that facilitates deploying disk images. Referring to FIG. 1, computer architecture 100 includes deployment module 101 and disk 102. Each of deployment module 101 and disk 102 can be connected to one another over (or be part of) a network, such as, for example, a Local Area Network (“LAN”), a Wide Area Network (“WAN”), and even the Internet. Accordingly, each of deployment module 101 and disk 102, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In one aspect, deployment module 101 and disk 102 are included in a data center environment.

Disk 102 can be a solid state drive (SSD), a magnetic hard disk, an optical hard disk, or other type of hardware storage device. Disk 102 can be divided into a plurality of different portions, such as, for example, different partitions. A composite disk image can be stored in one of the portions. The composite disk image can include common data blocks common to a plurality of different production disk images, unique blocks that can differ among at least some production disk images, and transformation rules defining how to transform the common data blocks and different combinations unique data blocks into any of a plurality of different production disk images.

In general, deployment module 101 is configured to receive image deployment requests and deploy corresponding production disk images. In response to an image deployment request for a production disk image, deployment module 101 can scan the transformation rules at a storage device. Deployment module 101 can identify a transformation rule for transforming a composite disk image into the requested production disk image. Deployment module 101 can apply the identified rule to the composite disk image to formulate the production disk image at the storage device. In one aspect, each production disk image is deployed as a Virtual Hard Drive (VHD).

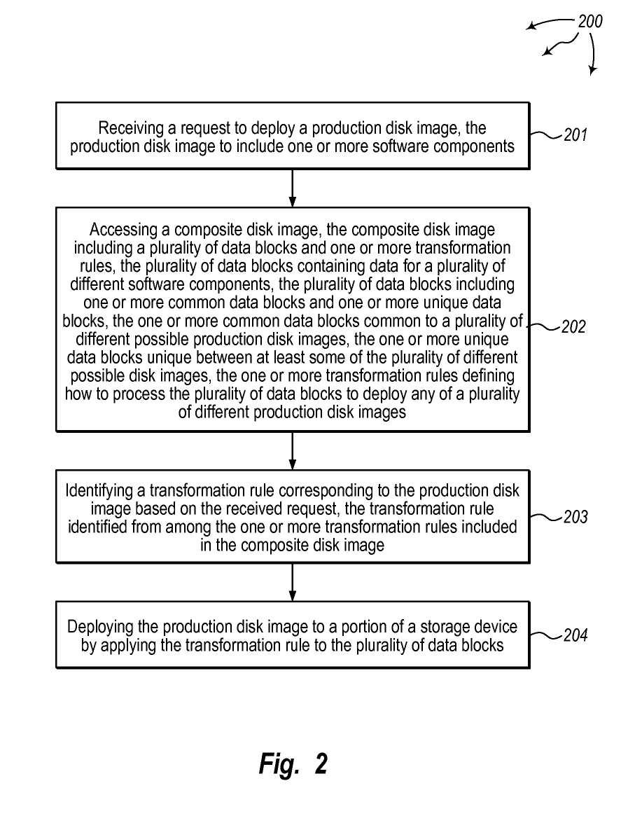

FIG. 2 illustrates a flow chart of an example method 200 for deploying disk images. Method 200 will be described with respect to the components and data of computer architecture 100.

Method 200 includes receiving a request to deploy a production disk image, the production disk image to include one or more software components (201). For example, deployment module 101 can receive image deployment request 111. Image deployment request 111 includes component identifiers 113I, 114I, and 116I. Each of component identifiers 113I, 114I, and 116I can identify a component that is to be included in a production disk image. In one aspect, one of the component identifiers 113I, 114I, and 116I identifies an operating system and other of the component identifiers 113I, 114I, and 116I identify software applications that are to run on the operating system.

In general, image deployment requests can originate from a (e.g., data center) user or customer that is desirous of staring up a production disk image.

Method 200 includes accessing a composite disk image, the composite disk image including a plurality of data blocks and one or more transformation rules, the plurality of data blocks containing data for a plurality of different software components, the plurality of data blocks including one or more common data blocks and one or more unique data blocks, the one or more common data blocks common to a plurality of different possible production disk images, the one or more unique data blocks unique between at least some of the plurality of different possible disk images, the one or more transformation rules defining how to process the plurality of data blocks to deploy any of a plurality of different production disk images (202). For example, deployment module 101 can access composite disk image 121. As depicted, disk 102 is partitioned into partitions 102A, 102B, 102C, and 102D. Composite disk image 121 is stored in partition 102A.

Composite disk image 121 includes common blocks 122, blocks 123, 124, and 125, and transformation rules 127. Common blocks 122 contains blocks common to a plurality of different possible production disk images. In one aspect, common blocks 122 contain blocks for an operating system (e.g., a network operating system). Blocks 123, 124, and 125 contain blocks unique between at least some of the plurality of different possible disk images. In one aspect, blocks 123, 124, and 125 each correspond to a different application that can run on the operating system (e.g., a Web server, a database management system, etc.).

Transformation rules 127 include transformation rules 127A, 127B, 127C, etc. Each of transformation rules 127A, 127B, 127C, etc. can define how to transform portions of composite disk image 121 into different corresponding production disk images. For example, transformation rule 127A can define how to transform composite disk image 121 into a production disk image with a network operating system having a web server and electronic commerce system running on the operating system. On the other hand, transformation rule 127B can define how to transform composite disk image 121 into a production disk image with the network operating system having a web server and database management system running on the operating system. Transformation rule 127C can define how to transform composite disk image 121 into a production disk image with an even different combination of software components.

In one aspect, each transformation rule includes component identifiers. The component identifiers identify software components that are to be included in a production disk image when composite disk image 121 is transformed by applying the transformation rule to composite disk image 121. Component identifiers in an image deployment request can be compared to component identifiers in transformation rules to identic a transformation rule corresponding to a requested production disk image.

Method 200 includes identifying a transformation rule corresponding to the production disk image based on the received request, the transformation rule identified from among the one or more transformation rules included in the composite disk image (203). For example, deployment module 101 can rule scan 117 transformation rules 127 for a transformation rule including component IDs 113I, 114I, and 116I (as well as any other component IDs in image deployment request 111). From rule scan 117, deployment module can identifying rule 127B.

Method 200 includes deploying the production disk image to a portion of a storage device by applying the transformation rule to the plurality of data block (204). For example, deployment module 101 can submit rule application 118 to apply rule 127B to composite disk image 121. Applying transformation rule 127B transforms common data blocks 122, block 123, and block 126 into production disk image 131 at partition 102D. Production disk image 131 includes software component 113 (e.g., an operating system) and software components 114 and 116 (e.g., applications that run on the operating system). Software component 113 is transformed from common data blocks 122, software component 114 is transformed from block 126, and software component 116 is transformed from block 123.

Within image deployment request 111, component IDs 113I, 114I, and 116I can identify software components 113, 114, and 116 respectively. Rule 127B can also include component IDs 113I, 114I, and 116I, indicating that application of rule 127B to composite disk image 121 transforms composite disk image 121 into a production disk image including software components 113, 114, and 116. Deployment module 101 can match image deployment request 111 to rule 127B by matching component IDs 113I, 114I, and 116I between image deployment request 111 and rule 127B.

In one aspect, deployment module 101 identifies an available partition. Alternately, in another aspect, disk 102 and/or a transformation rule identify an available partition. Deployment module 101 then applies the transformation rule to formulate a production disk image at the identified partition.

Formulating a production disk image can including copying and/or installing parts of composite disk image 121 to another partition of disk 102. For example, through application of rule 127B, deployment module 101 can copy and/or install parts of common data blocks 122 to form software component 113 at partition 102D. Similarly, deployment module 101 can copy and/or install parts of blocks 123 and 126 to form software components 114 and 116 respectively at partition 102D.

Additional production disk images can also be deployed to partitions 102B and 102C. The additional production disk images can be different production disk images or additional copies of production disk image 131.

For example, turning to FIG. 1B, deployment module 101 can receive image deployment request 141. Image deployment request 141 includes component IDs 113I, 114I, and 117I. Deployment module 101 can rule scan 137 transformation rules 127 for a transformation rule including component IDs 113I, 114I, and 117I (as well as any other component IDs in image deployment request 111). From rule scan 137, deployment module 101 can identify rule 127A.

Deployment module 101 can submit rule application 138 to apply rule 127A to composite disk image 121. Applying transformation rule 127A transforms common data blocks 122, block 124, and block 126 into production disk image 133 at partition 102B. Production disk image 131 includes software component 113 (e.g., an operating system) and software components 114 and 117 (e.g., applications that run on the operating system). Software component 113 is transformed from common data blocks 122, software component 114 is transformed from block 126, and software component 117 is transformed from block 124.

Turning to FIG. 1C, deployment module 101 can receive image deployment request 151. Image deployment request 151 includes component IDs 113I, 114I, and 116I. Deployment module 101 can rule scan 157 transformation rules 127 for a transformation rule including component IDs 113I, 114I, and 116I (as well as any other component IDs in image deployment request 111). From rule scan 157, deployment module 101 can identify rule 127B.

Deployment module 101 can submit rule application 158 to (again) apply rule 127B to composite disk image 121. Applying transformation rule 127B transforms common data blocks 122, block 123, and block 126 into (another copy of) production disk image 131 at partition 102C. Production disk image 131 includes software component 113 (e.g., an operating system) and software components 114 and 116 (e.g., applications that run on the operating system). Software component 113 is transformed from common data blocks 122, software component 114 is transformed from block 126, and software component 116 is transformed from block 123.

Accordingly, composite disk image 121 can be transformed multiple times to deploy different production disk images and/or to deploy multiple copies of the same production disk image at disk 102.

Formulating a production disk image can also include creating a file table (e.g., a file allocation table) with entries in the file table pointing back to blocks in a composite disk image.

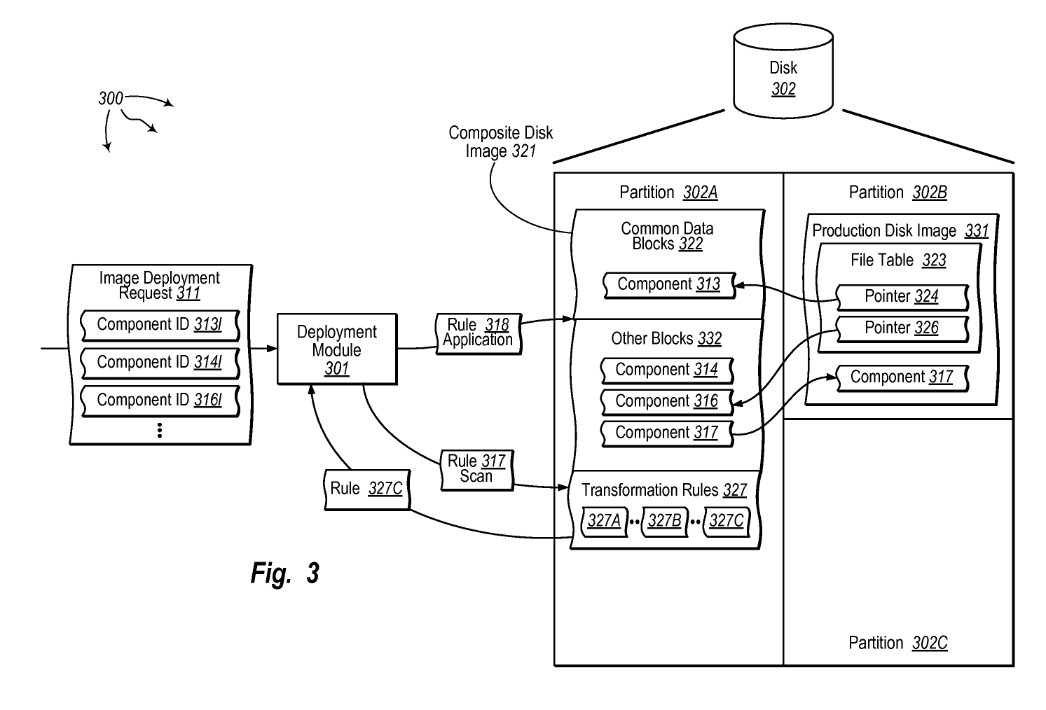

Turning to FIG. 3, FIG. 3 illustrates an example computer architecture 300 that facilitates deploying disk images. Referring to FIG. 3, computer architecture 300 includes deployment module 301 and disk 302. Each of deployment module 301 and disk 302 can be connected to one another over (or be part of) a network, such as, for example, a Local Area Network (“LAN”), a Wide Area Network (“WAN”), and even the Internet. Accordingly, each of deployment module 101 and disk 102, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

In one aspect, deployment module 301 and disk 302 are included in a data center environment.

Disk 302 can be a solid state drive (SSD), a magnetic hard disk, an optical hard disk, or other type of hardware storage device. Disk 302 can be divided into a plurality of different portions, such as, for example, different partitions. A composite disk image can be stored in one of the portions. The composite disk image can include common data blocks common to a plurality of different production disk images, unique blocks that can differ among at least some production disk images, and transformation rules defining how to transform the common data blocks and different combinations unique data blocks into any of a plurality of different production disk images. As depicted, disk 302 is partitioned into partitions 302A, 302B, and 302C. Composite disk image 321 is stored in partition 302A.

Composite disk image 321 includes common blocks 322, other blocks 332, and transformation rules 327. Common blocks 322 contains software component 313 (and possible other software components) common to a plurality of different production disk images. Other blocks 322 contain software components 314, 316, and 318 that can differ among at least some production disk images. Transformation rules 327 include transformation rules 327A, 327B, 327C, etc. Each of transformation rules 327A, 327B, 327C, etc. can define how to transform portions of composite disk image 321 into different corresponding production disk images.

In general, deployment module 301 is configured similarly to deployment module 101. Deployment module 301 can receive image deployment requests and deploy corresponding production disk images. In response to an image deployment request for a production disk image, deployment module 301 can scan the transformation rules at a storage device. Deployment module 301 can identify a transformation rule for transforming a composite disk image into the requested production disk image. Deployment module 301 can apply the identified rule to the composite disk image to formulate the production disk image at the storage device.

As such, deployment module 301 can receive image deployment request 311. Image deployment request 311 includes component IDs 313I, 314I, and 316I. Deployment module 301 can rule scan 317 transformation rules 327 for a transformation rule including component IDs 313I, 314I, and 316I (as well as any other component IDs in image deployment request 311). From rule scan 317, deployment module 301 can identify rule 327C (e.g., a transformation rule that matches to component IDs 313I, 314I, and 316I).

Deployment module 301 can submit rule application 318 to apply rule 327C to composite disk image 321. Applying transformation rule 327C causes production disk image 331 to be formulated at partition 302B. Production image 331 includes file table 323. File table 323 includes pointers 324 and 326 pointing back to software components 313 and 316 respectively. Production image 331 also includes component 317 copied from other blocks 332.

In one aspect, components 313 and 316 are read only components. Thus, multiple different production disk images can include pointers pointing back to components 313 and 316. In another aspect, multiple copies of components 313 and 316 are included in composite disk image 321. In this other aspect, different production disk images can include pointers pointing back to different copies of components 313 and 316. When pointers are used, the density of production disk images on a storage device can potentially be increased.

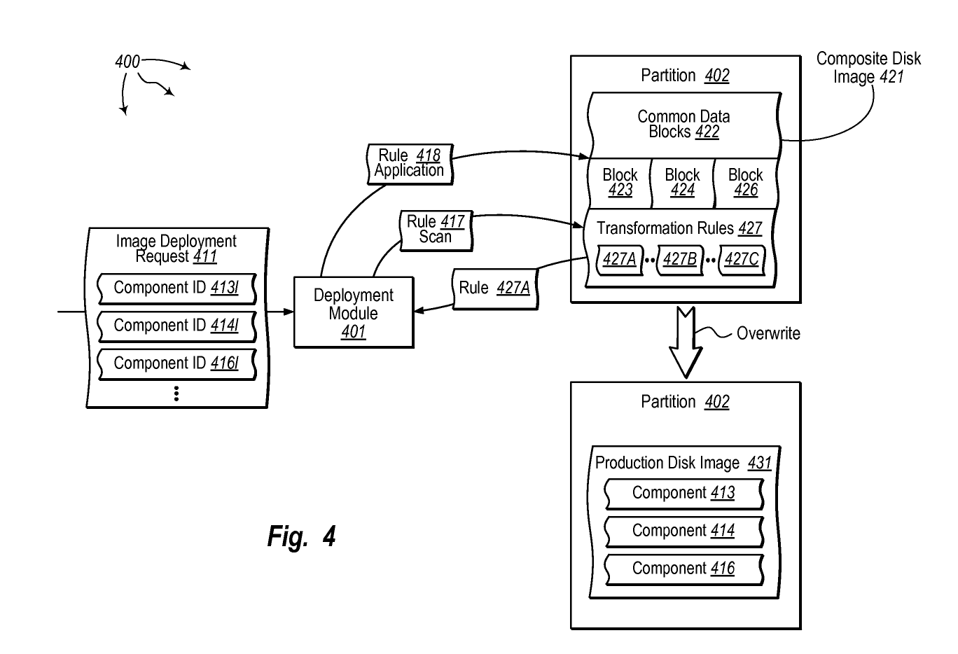

FIG. 4 illustrates an example computer architecture that facilitates deploying disk images. Referring to FIG. 4, computer architecture 400 includes deployment module 401 and partition 402. Each of deployment module 401 and partition 402 can be connected to one another over (or be part of) a network, such as, for example, a Local Area Network (“LAN”), a Wide Area Network (“WAN”), and even the Internet. Accordingly, each of deployment module 101 and disk 102, as well as any other connected computer systems and their components, can create message related data and exchange message related data (e.g., Internet Protocol (“IP”) datagrams and other higher layer protocols that utilize IP datagrams, such as,

Transmission Control Protocol (“TCP”), Hypertext Transfer Protocol (“HTTP”), Simple Mail Transfer Protocol (“SMTP”), etc. or using other non-datagram protocols) over the network.

In one aspect, deployment module 401 and partition 402 are included in a data center environment.

Partition 402 can be a partition at a solid state drive (SSD), a magnetic hard disk, an optical hard disk, or other type of hardware storage device. As depicted, composite disk image 432 is stored at partition 431.

Composite disk image 431 includes common blocks 422, blocks 423,424, and 426, and transformation rules 427. Common blocks 422 contain software components common to a plurality of different production disk images. Other blocks 423, 424, and 426 contain software components that can differ among at least some production disk images. Transformation rules 427 include transformation rules 427A, 427B, 427C, etc. Each of transformation rules 427A, 427B, 4327C, etc. can define how to transform portions of composite disk image 421 into different corresponding production disk images.

In general, deployment module 401 is configured similarly to deployment modules 101 and 301. Deployment module 401 can receive image deployment requests and deploy corresponding production disk images. In response to an image deployment request for a production disk image, deployment module 401 can scan the transformation rules at a storage device. Deployment module 401 can identify a transformation rule for transforming a composite disk image into the requested production disk image. Deployment module 401 can apply the identified rule to the composite disk image to formulate the production disk image at the storage device.

As such, deployment module 401 can receive image deployment request 411. Image deployment request 411 includes component IDs 413I, 414I, and 416I. Deployment module 401 can rule scan 417 transformation rules 427 for a transformation rule including component IDs 4131, 4141, and 4161 (as well as any other component IDs in image deployment request 411). From rule scan 417, deployment module 401 can identify rule 427A (e.g., a transformation rule that matches to component IDs 413I, 414I, and 416I).

Deployment module 401 can submit rule application 418 to apply rule 427A to composite disk image 421. Applying transformation rule 427A transforms common data blocks 422, block 423, and block 426 into production disk image 431 at partition 402. That is, applying transformation rule 427A causes composite disk image 421 to be overwritten with production disk image 431. Production disk image 431 includes software component 413 (e.g., an operating system) and software components 414 and 416 (e.g., applications that run on the operating system). Software component 413 is transformed from common data blocks 422, software component 414 is transformed from block 423, and software component 416 is transformed from block 426.

In general, different aspects of the invention can be used in combination. For example, at the same storage device, one production disk image can be generated from locally copying software components from a composite disk image and another production disk image can be generated using pointers to point back to software components in the composite disk image. As described, a production disk image can include both pointers pointing back to software components in a composite disk image (e.g., read only software components) and other software components copied from the composite disk image.

Alternately, at the same storage device, one production disk image can be generated from locally copying software components from a composite disk image and another production disk image can be generated from overwriting a partition containing the composite disk image.

Overwriting a partition can be useful for deploying a production image when other partitions at a storage device are already consumed. For example, referring briefly back to FIG. 1C, when an additional production disk image is requested, it may be useful to overwrite composite disk image 121 with the production disk image at partition 102A since partitions 102B, 102C, and 102D are already hosting other production disk images.

Prior to forming a composite disk image, various common disk images can be examined within a data center to identify a set of blocks that match between multiple, related images (i.e., the common blocks). Both the common blocks and different blocks can be stored in a composite disk image. When a request for a machine running a specific image is made, a centralized system can find hardware with a pre-cached composite disk image and request a production disk image be formulated from the composite disk image.

The centralized system can pre-calculate the transformations for transforming a composite disk image into a variety of possible production disk images. As such, a lightweight process running on a server, for example, in a hypervisor, to receive instructions from a remote controller to transform the composite disk image into a desired production disk image. The process can then execute the pre-calculated transformation and install the mappings of the data to the directories as required by the file system of the production disk image.

As a security measure, unused unique blocks belonging to other related images can be securely overwritten and deleted to prevent access to that data. Another option includes storing unique blocks of data in a separate data space on a local disk and copying the data into the space needed by the new partition. Yet another option of securing unique blocks includes growing the space required to store the composite disk images. For example, the size needed to store the composite disk image can be set to the size of the largest final partition plus the amount of space to store the unique data blocks. The unique blocks can optionally be compressed to reduce the overhead required to store the data.

Transformations can be used to update a disk partition map to tell an operating system how to locate and hints on how to mount partitions stored on a drive. In one aspect, is to put incorrect information in the partition map and claim to be a type of file system the final file system is to be. For example, if a composite disk image is to store variations of a specified file system (e.g., NTFS), the partition map can be written to indicate that a composite disk image is a partition of the specified file system (even if data is not stored in a way that can be mounted as a drive in the specified file system).

Another option is identify a composite disk image as a transformative file system. When the system transforms the composite disk image to a final file system, a partition map is updated to identify the final file system with the final file system type and size.

In one aspect, different tranches of composite disk images are maintained for differing base images. As such, overhead associated with deploying production disk images can also be reduced even when there is some increased differences between a plurality of base images, such as, for example, different versions and revisions of operating systems.

In general, aspects of the invention facilitate more efficient formulation of production disk images by manipulating data locally at a storage device and minimizing network communications.

The present invention may be implemented in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for deploying a production disk image, the method comprising:
receiving a request to deploy a production disk image, the production disk image to include one or more software components;
accessing a composite disk image, the composite disk image including a plurality of data blocks and one or more transformation rules, the plurality of data blocks containing data for a plurality of different software components, the plurality of data blocks including one or more common data blocks and one or more unique data blocks, the one or more common data blocks common to a plurality of different possible production disk images, the one or more unique data blocks unique between at least some of the plurality of different possible disk images, the one or more transformation rules defining how to process the plurality of data blocks to deploy any of a plurality of different production disk images;
identifying a transformation rule corresponding to the production disk image based on the received request, the transformation rule identified from among the one or more transformation rules included in the composite disk image; and
deploying the production disk image to a portion of a storage device by applying the transformation rule to the plurality of data blocks.

2. The method of claim 1, wherein accessing a composite disk image comprises accessing a composite disk image from another portion of the storage device; and
wherein deploying the operational disk image to a portion of a storage device comprises copying the one or more common data blocks and at least one of the one or more unique data blocks to the portion of the storage device in accordance with the transformation rule.

3. The method of claim 2, wherein the portion of the storage device is a partition of the storage device and wherein the other portion of the storage device is another different partition of the storage device.

4. The method of claim 1, wherein deploying the operational disk image to a portion of a storage device comprises formulating a file allocation table, the file allocation table including an entry pointing to the one or more common data blocks and another entry pointing to the at least one of the one or more unique data blocks.

5. The method of claim 1, wherein accessing a composite disk image comprises accessing a composite disk image from the portion of the storage device; and
wherein deploying the operational disk image to a portion of a storage device comprises applying the transformation rules to transform the one or more common data blocks and one or more unique data blocks to form the production image at the portion of the storage device.

6. The method of claim 1, wherein deploying the production disk image to a portion of a storage device comprises deploying a virtual hard drive (VHD).

7. The method of claim 1, further comprising:
receiving further request to deploy a second different production disk image, the second different production disk image to include a plurality of different software components;
identifying a second transformation rule corresponding to the second different production disk image based on the received further request, the second transformation rule identified from among the one or more transformation rules included in the composite disk image; and
deploying the second different production disk image to another portion of a storage device by applying the second transformation rule to the plurality of data blocks.

8. The method of claim 1, further comprising:
receiving a further request to deploy the production disk image;
deploying the production disk image to another portion of the storage device by applying the transformation rule to the plurality of data blocks.

9. The method of claim 1, wherein accessing a composite disk image comprises accessing a composite disk image including one or more common blocks of an operating system and a plurality of unique blocks, each of the plurality of unique blocks corresponding to an application that runs within the operating system.

10. A computer program product for use at a computer system, the computer program product for implementing method for deploying a production disk image, the computer program product comprising one or more computer storage devices having stored thereon computer-executable instructions that, when executed at a processor, cause the computer system to perform the method, including the following:
receive a request to deploy a production disk image, the production disk image to include one or more software components;
access a composite disk image, the composite disk image including a plurality of data blocks and one or more transformation rules, the plurality of data blocks containing data for a plurality of different software components, the plurality of data blocks including one or more common data blocks and one or more unique data blocks, the one or more common data blocks common to a plurality of different possible production disk images, the one or more unique data blocks unique between at least some of the plurality of different possible disk images, the one or more transformation rules defining how to process the plurality of data blocks to deploy any of a plurality of different production disk images;
identify a transformation rule corresponding to the production disk image based on the received request, the transformation rule identified from among one or more transformation rules included in the composite disk image; and
deploy the production disk image to a portion of a storage device by applying the transformation rule to the plurality of data blocks.

11. The computer program product of claim 10, wherein computer-executable instructions that, when executed, cause the computer system to access a composite disk image comprise computer-executable instructions that, when executed, cause the computer system to access a composite disk image from another portion of the storage device; and
wherein computer-executable instructions that, when executed, cause the computer system to deploy the operational disk image to a portion of a storage device comprises computer-executable instructions that, when executed, cause the computer system to copy the one or more common data blocks and at least one of the one or more unique data blocks to the portion of the storage device in accordance with the transformation rule.

12. The computer program product of claim 10, wherein computer-executable instructions that, when executed, cause the computer system to deploy the operational disk image to a portion of a storage device comprise computer-executable instructions that, when executed, cause the computer system to formulate a file allocation table, the file allocation table including an entry pointing to the one or more common data blocks and another entry pointing to the at least one of the one or more unique data blocks.

13. The computer program product of claim 10, wherein computer-executable instructions that, when executed, cause the computer system to access a composite disk image comprise computer-executable instructions that, when executed, cause the computer system to access a composite disk image from the portion of the storage device; and
wherein computer-executable instructions that, when executed, cause the computer system to deploy the operational disk image to a portion of a storage device comprise computer-executable instructions that, when executed, cause the computer system to apply the transformation rules to transform the one or more common data blocks and one or more unique data blocks to form the production image at the portion of the storage device.

14. The computer program product of claim 10, further comprising computer-executable instructions that, when executed, cause the computer system to:
receive a further request to deploy a second different production disk image, the second different production disk image to include a plurality of different software components;
identify a second transformation rule corresponding to the second different production disk image based on the received further request, the second transformation rule identified from among the one or more transformation rules included in the composite disk image; and
deploy the second different production disk image to another portion of a storage device by applying the second transformation rule to the plurality of data blocks.

15. The computer program product of claim 10, further comprising computer-executable instructions that, when executed, cause the computer system to:
receive a further request to deploy the production disk image;
deploy the production disk image to another portion of the storage device by applying the transformation rule to the plurality of data blocks.

16. The computer program product of claim 10, wherein computer-executable instructions that, when executed, cause the computer system to access a composite disk image comprise computer-executable instructions that, when executed, cause the computer system to access a composite disk image including one or more common blocks of an operating system and a plurality of unique blocks, each of the plurality of unique blocks corresponding to an application that runs within the operating system.

17. A computer system, the computer system comprising:
one or more processors;
system memory; and
one or more computer storage devices having stored thereon:
a composite disk image, the composite disk image including a plurality of data blocks and one or more transformation rules, the plurality of data blocks containing data for a plurality of different software components, the plurality of data blocks including one or more common data blocks and one or more unique data blocks, the one or more common data blocks common to a plurality of different possible production disk images, the one or more unique data blocks unique between at least some of the plurality of different possible disk images, the transformation rules defining how to process the plurality of data blocks to deploy any of a plurality of different production disk images; and
computer-executable instructions representing a deployment module, the deployment module configured to:
receive a request to deploy a production disk image, the production disk image to include one or more software components;
access the composite disk image;
identify a transformation rule corresponding to the production disk image based on the received request, the transformation rule identified from among the plurality of transformation rules included in the composite disk image; and
deploy the production disk image to a portion of a storage device by applying the transformation rule to the plurality of data blocks, the storage device selected from among the one or more computer storage devices.

18. The computer system of claim 17, wherein the deployment module is further configured to:
receive a further request to deploy a second different production disk image, the second different production disk image to include a plurality of different software components;
identify a second transformation rule corresponding to the second different production disk image based on the received request, the second transformation rule identified from among the one more transformation rules included in the composite disk image; and
deploy the second different production disk image to another portion of the storage device by applying the second transformation rule to the plurality of data blocks.

19. The computer system of claim 17, wherein the deployment module is further configured to:
receive a further request to deploy the production disk image;
deploy the production disk image to another portion of the storage device by applying the transformation rule to the plurality of data blocks.

20. The computer system of claim 17, wherein deployment module being configured to deploy the production disk image comprises the deployment module being configured to deploy a virtual hard drive (VHD).
